(19) United States
(12) Patent Application Publication
(10) Pub. No.: US 2022/0227119 A1
(43) Pub. Date: Jul. 21, 2022

(54) INTAGLIO PRINTING PLATE WITH PRESSURE RELIEF FEATURE FOR SECURITY DOCUMENTS AND METHOD FOR MAKING THE SAME

(71) Applicant: Canadian Bank Note Company, Limited, Ottawa (CA)

(72) Inventor: Jason ROOSEN, Renfrew (CA)

(21) Appl. No.: 17/617,071

(22) PCT Filed: Jun. 12, 2020
(86) PCT No.: PCT/CA2020/050815

§ 371 Date: Dec. 7, 2021

(30) Foreign Application Priority Data
Jun. 12, 2019 (CA) 3046216

(51) Int. Cl. B41F 11/02; B41N 1/06

(52) U.S. Cl. CPC B41F 11/02; B41N 1/06

(57) ABSTRACT

An intaglio printing plate is configured to protect a micro optics, RFID or chip feature of a security document during the process of intaglio printing the security document which applies very high pressure that could otherwise damage the micro optics, RFID or chip feature. A method for making the printing plate is also provided. The printing plate comprises a pressure relief depression located to coincide with the micro optics, RFID or chip feature during printing of a substrate of the security document. The pressure relief depression has a depth between 30-120 microns and shape corresponding to the shape of the micro optics, RFID or chip feature.

### FIELD OF THE INVENTION

The invention relates generally to intaglio printing and particularly to improved intaglio printing plates for printing on security documents having a micro optics feature or another feature that cannot be calendared by a conventional intaglio plate (for example, RFID inlay or chip).

### BACKGROUND

Micro optics features are becoming a popular security feature option for bank notes and possibly other security documents. The micro optics features may include lenses for example. These features create a thicker protrusion or bulge on the bank note that can be negatively affected by intaglio printing. The high pressure exerted by the intaglio plate and impression cylinder can damage the lens or other feature of a micro optics feature and may even make it ineffective. It has also been found to hinder the printing process because the bulge negatively affects the bank note sheets in the intaglio delivery.

RFID or micro chips may soon be integrated into banknotes. These would also require protection from the high pressures of intaglio printing.

### SUMMARY

The invention provides an intaglio printing plate configured for protecting a security feature such as a micro optics, RFID or chip feature of a security document while printing the security document. The printing plate comprises a pressure relief depression located to coincide with the micro optics, RFID or chip feature during printing of a substrate of the security document. The pressure relief depression has a depth between 30-120 microns and shape corresponding to the shape of the micro optics, RFID or chip feature.

Also in accordance with the invention there is provided a method for making an intaglio printing plate configured for protecting a security feature such as a micro optics, RFID or chip feature of a security document during printing of the security document by the printing plate. The method comprises: (a) mapping the micro optics, RFID or chip feature to corresponding contour depths of a three dimensional pressure relief depression; (b) forming a printing plate mold with a pressure relief depression having contour depths according to the mapping; and, (c) forming the intaglio printing plate from the printing plate mold wherein the intaglio printing plate comprises a pressure relief depression identical to that of the printing plate mold.

### BRIEF DESCRIPTION OF THE DRAWINGS

The invention is described herein with reference to the following drawings for which like reference numerals refer to like components throughout.

FIG. 1 illustrates an intaglio plate cylinder (P) and an impression cylinder (I) of a Super Intaglio Orlof KBA™ printing press.

FIG. 2 depicts an uneven bulge in a delivered stack of bank note security documents having a micro optical feature (comprising a lens) from an intaglio printing press, the bulge resulting indirectly from high pressure applied to and damaging the micro optical feature by the intaglio plate(s) of the printing press cylinder(s). The intaglio pressure changes the properties of the micro optical feature and the sheets cannot be delivered as a result.

FIG. 3 depicts an exemplary impression board with pressure relief cut-outs formed therein for use between the intaglio plate(s) and security documents to prevent the bulge shown by FIG. 2 that is caused by pressure damage to the micro optical features of the security documents.

FIG. 4 depicts a delivered stack of bank note security documents having a micro optical feature (comprising a lens) from an intaglio printing press when an impression board as shown by FIG. 3, having pressure relief cut-outs, is used.

FIG. 5 is an image of an exemplary shape of a pressure relief depression in accordance with the present invention wherein the lines represent different assigned depths of the depression.

FIG. 6 depicts an intaglio printing plate comprising a pressure relief depression in accordance with the present invention.

FIG. 7 is a schematic drawing of a part of a laser engraved plate showing a pressure relief depression formed in the plate.

FIG. 8 is a schematic drawing of a part of an intermediary plate used to form a master plate using an electrolytic plate forming process.

FIG. 9 is a schematic drawing of a part of a sample printing plate in accordance with the present invention made from a master plate.

### DETAILED DESCRIPTION

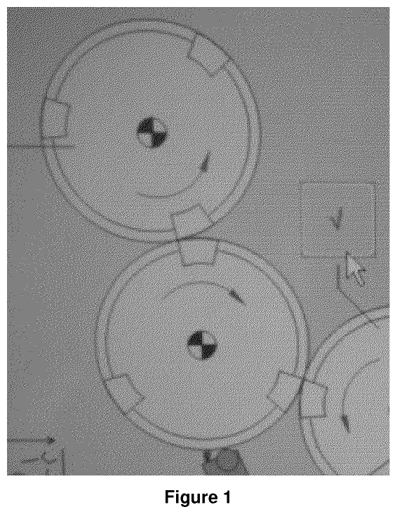

FIG. 1 illustrates an intaglio plate cylinder (P) and an impression cylinder (I) of an exemplary intaglio printing press, namely, a Super Intaglio Orlof KBA™ press, in which the present invention is used. However, it to be understood that the present invention is for use with intaglio printing presses generally and is not limited to any type or make of printing press. In the printing press of FIG. 1, three intaglio printing plates are mounted on the plate cylinder (P) and each of these printing plates comes in contact with one of three impression boards mounted on the impression cylinder (I).

Micro optics security features such as holograms are frequently incorporated into bank note substrates and then the bank note substrate is printed by an intaglio printing press. The bank note substrate may be selected for a given application and, for example, may be comprised of polymer, paper, or any combination of these and/or other materials that are suitable.

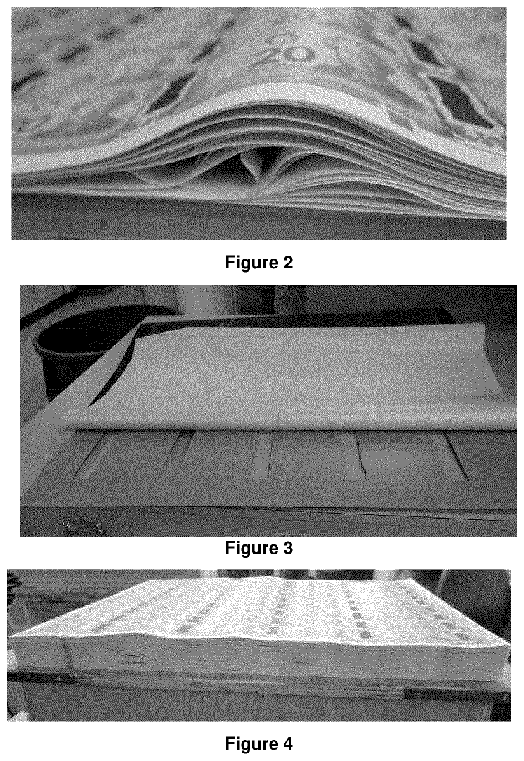

FIG. 2 illustrates a stack of exemplary 20 dollar bank notes in the intaglio delivery after printing by a convention intaglio printing press as shown in FIG. 1. As shown in FIG. 2 each bank note incorporates a micro optics security feature, shown as generally rectangular transparent or translucent strip extending along one side of the bank note. In the intaglio delivery stack shown by FIG. 2 an uneven bulge in the area between successive micro optics features of bank notes, results from the high pressure exerted by the intaglio plate and impression cylinder of the printing press. This can damage the micro optics security feature or change its properties and interfere with the delivery process of the printing.

In printing test trials the inventor tested impression cards with rectangular cut-outs, as illustrated in FIG. 3 (the bottom sheet), on the impression cylinder (I) to determine the effect of providing a hollow depression in the press area of the micro optics feature. This demonstrated the feasibility of using a suitable pressure relief mechanism. However, the cutting of impression cards is considered to be too time consuming to be used on large banknote production runs, and test trial did not provide a satisfactory degree of reproducibility or repeatability. Further, it was found that when a paper bank note substrate is used with the impression cards it was not possible to hide the transition from calendared to uncalendared stock and a visible impression produced a negative aesthetic effect.

The present invention solves these problems by providing a pressure relief design element in the intaglio printing plate to compensate for the height of the micro optics feature. Advantageously, this enables controllability and repeatability, as well as hiding the transition between the different areas.

In prepress, a technician or engraver uses a 2-dimensional (2D) design of the micro optics feature (or design area to be protected) and converts or translates this into a 3-dimensional form to be subsequently engraved or formed by computer controlled milling machine into a plate material to produce an intaglio printing plate with a pressure relief depression. To map the plate depression form to the micro optics feature a depth between approximately 30 and 120 microns is assigned to each of a number of contour lines of the 2D design. The plate material is hollowed out according to the mapping to form a depression which provides pressure relief.

Once this prepress step has been completed a master plate mold is made by a laser engraving process to create a depression having a form according to the foregoing mapping in laserable plate material or, alternatively, using a computer stepped milling machine. Advantageously, these are computer-generated so every reproduction produced by the plate will be identical in shape and position on security documents processed by the plate. Another advantage of using computer generated laser engraving or computer controlled milling is that they permit the shoulders of the pressure relief depression to be gradually rounded and tapered in order to hide the transition between areas under impression and areas that are protected by the depression. Applying a rounded edge also prevents any sudden pressure change that would risk sheering the substrate being printed whereas this would not be possible if a cut-out impression board were to be used.

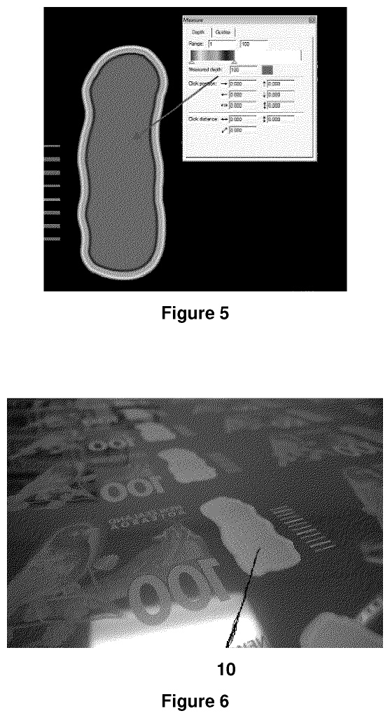

The image shown in FIG. 5 is an example of a mapping used to form a pressure relief depression or hollow in a printing plate for use in printing bank notes as shown FIGS. 2 and 4. The design is irregular and follows the contours of the micro optics feature to be protected, in this case following the contours of the bank note window that includes the micro optics feature. Both hard edged and sharp corners should be avoided to better hide and integrate the depression. FIG. 6 shows a number of completed intaglio printing plates, each containing a 100-micron pressure relief depression 10 located where a window foil of a bank note substrate will be during printing.

Following the fabrication of the master plate mold an electrochemical or vapour deposition process is used to protect it. The master plate mold is the original source from which working printing plates, such as those shown in FIG. 6, are replicated, in inverse form, by electrochemistry or vapour deposition methods. The master plate mold is an inverse of the working plates so each working plate has a bulge or protuberance corresponding to the pressure relief depression of the master plate where the micro optics feature (or other feature) to be protected will line up during printing. The intaglio printing plates formed from the master plate mold will all be virtually identical. They are chromed and used in the production of bank notes.

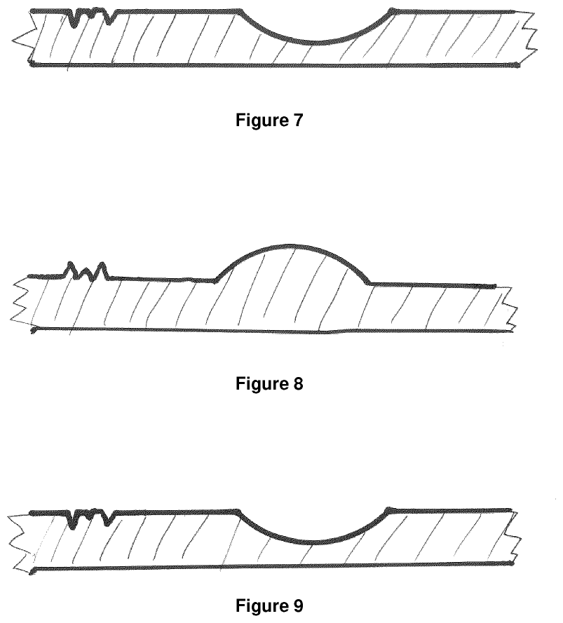

FIG. 7 is a schematic drawing of a part of a laser engraved plate with a pressure relief depression that is made with either nickel or another material compatible with the electrolytic plate forming process. FIG. 8 is a schematic drawing of a part of an intermediate plate mold used to form a master plate using an electrolytic plate forming process. FIG. 9 is a schematic drawing of a part of a working intaglio printing plate in accordance with the present invention made from a nickel master plate, all plates formed therefrom containing an identical depression in the same location relative other engraved elements on the plate (one such engraved element shown to the left of the depression).

The pressure relief depression 10 has a maximum depth of 300 microns and a minimum depth of 30 microns. Usually no more than 100 microns will be required, however where a milling machine is used to form the depression a greater depth may be desired. The shape of the pressure relief depression is preferably irregular and follows the shape of the document feature design to be protected. However, the shape may be a regular shape such as a geometric shape when the design permits it and where the transition to the hollow is gradual, for example, 0 to 120 microns over 0.5 mm. The size of shape can span from the top to the bottom of the security document (e.g. bank note). A width of less than one third of the document may be selected for an embodiment. Depending on the application other widths may be appropriate for selection. No intaglio print is applied in the area of the pressure relief depression.

The present invention may be used on paper, polymer, polycarbonate and combinations thereof for any security printed document that requires both intaglio printing and pressure relief on the same document.

The present invention may be used to protect a feature of the document, or to protect part of the substrate from calendaring under pressure.

The present invention is for use with any security feature having a height that stands up from the substrate by more than 15 microns.

In some embodiments, a texturing (as shallow as 30 microns) can be used on the intaglio plate to change the surface properties of the feature that is to be protected. In this case, the pressure relief is only partially applied against the feature and the texture from the plate is transferred like an emboss.

1. An intaglio printing plate configured for protecting at least one previously incorporated security feature of a security document having a shape while printing the security document, the printing plate comprising a pressure relief depression located to coincide with the shape of the security feature wherein the pressure relief depression has a depth between 30 and 300 microns and a contour corresponding to the shape of the security feature.

2. A method for making an intaglio printing plate configured for protecting at least one previously incorporated security feature of a security document during printing of the security document by the printing plate, the method comprising: (a) mapping the security feature to corresponding contour depths of a three dimensional pressure relief depression; (b) forming a printing plate mold with a pressure relief depression having contour depths according to the mapping; and, (c) forming the intaglio printing plate from the printing plate mold wherein the intaglio printing plate comprises a pressure relief depression identical to that of the printing plate mold.

3. The intaglio printing plate according to claim 1 wherein the depth of the pressure relief depression is between 30 and 120 microns.

4. The intaglio printing plate according to claim 1 wherein the pressure relief depression has gradually tapered shoulders, thereby providing a gradual transition between the pressure relief depression and a remainder of the intaglio printing plate.

5. The intaglio printing plate according to claim 1 wherein the pressure relief depression constitutes at most one third a width of the intaglio printing plate.

6. The intaglio printing plate according to claim 1 wherein the security feature has a height of at least 15 microns.

7. The intaglio printing plate according to claim 1 further comprising a textured portion wherein at least part of the textured portion coincides with at least a part of the security feature, and wherein the pressure relief depression coincides with only a portion of the security feature.

8. (canceled)

9. A method for printing a substrate of a security document having at least one previously incorporated security feature having a shape comprising the steps of:
a) obtaining the substrate comprising the at least one previously incorporated security feature; and
b) printing on the substrate using an intaglio printing plate configured for protecting the at least one security feature,
wherein the intaglio printing plate comprises at least one pressure relief depression located to coincide with the at least one security feature during printing of the substrate of the security document and wherein the at least one pressure relief depression has a depth between 30 and 300 microns and a contour corresponding to the shape of the at least one security feature.

10. The method according to claim 9 wherein the security feature is a member of a group consisting of a micro optic, RFID, and a chip.

11. The intaglio printing plate according to claim 1 wherein the pressure relief depression constitutes at most one third a width of the security document.

12. The method according to claim 2 wherein the security feature is a member of a group consisting of a micro optic, RFID, and a chip.

13. The method according to claim 2 wherein the pressure relief depression has a depth between 30 and 120 microns.

14. The method according to claim 2 wherein the pressure relief depression is formed by a laser engraving process.

15. The method according to claim 2 wherein the pressure relief depression is formed by a computer stepped milling machine.
